(19) United States
(12) Patent Application Publication
(10) Pub. No.: US 2010/0191989 A1
(43) Pub. Date: Jul. 29, 2010

(54) System And Method For Power Management At An Information Handling System Management Subsystem

(76) Inventors: Mukund P. Khatri, Austin, TX (US); Timothy M. Lambert, Austin, TX (US)

Correspondence Address: HAMILTON & TERRILE, LLP, P.O. BOX 203518, AUSTIN, TX, 78720, US

(21) Appl. No.: 12/361,852

(22) Filed: Jan. 29, 2009

(51) Int. Cl. G06F 1/32; G06F 1/00

(52) U.S. Cl. 713/310; 713/320; 713/322

(57) ABSTRACT

An information handling system management subsystem power manager adjusts power consumption of the management subsystem based on operational conditions at the information handling system. The power manager powers down the management subsystem when the information handling system is powered down so that the management subsystem performs substantially only those functions needed to reboot itself to an operational state. If a power up command is received, the management subsystem reboots to an operational condition so that it can then restart the information handling system. In one embodiment, the power manager adjusts the clock of a processor that executes the management subsystem to maintain utilization of the processor within a predetermined range.

### BACKGROUND OF THE INVENTION

1. Field of the Invention

The present invention relates in general to the field of information handling system power management, and more particularly to a system and method for power management at an information handling system management subsystem.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have advanced and proliferated, many server information handling systems have come to incorporate management subsystems. These management subsystems monitor operating conditions associated with the information handling system and offer “out-of-band” communications to support remote management functions, such as remote power up and power down. One example of such a management subsystem is the Baseboard Management Controller (BMC) found on many server information handling systems which controls application of power to the system, allows out of band communication through a management interface, and controls operating temperatures through management of a cooling subsystem. Another example of a management subsystem is the Chassis Management Controller (CMC) found on chassis-based servers, such as blade servers. CMCs allocate power and cooling resources between multiple information handling systems supported by a chassis and coordinate out of band communications with BMCs integrated in the information handling systems.

Although management subsystems provide an increasing number of management functions, the increasing complexity of the management functions and the capabilities needed in the processing components used to build management subsystems has resulted in increased power consumption by the management subsystems. For example, a typical management subsystem that provides full management capabilities with the speed and performance desired by end users, such as remote access, Wake-On-LAN access, shared NIC access and full managed storage functionality, consumes 30 Watts while planned management subsystems may consume as much as 100 Watts. Auxiliary power that supports operation of management subsystems typically comes from Power Supply Units (PSU) that provide primary power but that have inherently worse efficiency with the relatively light power consumption loads, thus increasing power waste. The increased power use and inefficiency associated with operation of management subsystems means that cooling fans must sometimes be used to provide cooling airflow to the management subsystem. This not only further increases power consumption but also increases system noise and vibration, even when the server information handling system being managed is itself powered down. The usefulness of management subsystems is reduced where power consumption by the management subsystem detracts from power savings available through remote shutdown of server information handling systems during reduced workloads.

### SUMMARY OF THE INVENTION

Therefore a need has arisen for a system and method which reduces power consumption by information handling system management subsystems.

In accordance with the present invention, a system and method are provided which substantially reduce the disadvantages and problems associated with previous methods and systems for power management of information handling systems. A power manager running on a management subsystem selectively adapts power consumption by the management subsystem based on one or more predetermined conditions, such as the operational state of the managed information handling system and the management subsystem.

More specifically, an information handling system is managed by a management subsystem, such as a baseboard management controller that supports remote power up and power off of the information handling system through a network interface. A power manager running on the management subsystem adjusts power consumption of the management subsystem, such operating conditions at the information handling system under management by the management subsystem. In one embodiment, the power manager powers down the management subsystem to a reduced power state when the information handling system is powered down so that the management subsystem functions substantially only to recover to an operational state in the event of a wake command, such as a packet sent through a network or an input at a power button. Once the management subsystem recovers to an operational state, the power manager adjusts peripherals that support the management subsystem to reduce power consumption and adjusts clock speed of a management processor that runs the management subsystem to maintain a utilization range that accomplishes management functions with reduced power consumption.

The present invention provides a number of important technical advantages. One example of an important technical advantage is that information handling systems having a management subsystem can power down to reduced power states that also reduces the power consumed by the management subsystem. During reduced workloads, data centers can power down selected server information handling systems and place their management subsystems in reduced power consumption modes where the management systems remain available for remote management through a wakeup from the powered down mode. Data centers are thus able to take full advantage of power savings through workload allocation and idle system shut down since power consumption and cooling associated with management systems remains minimal for powered down server information handling systems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a management subsystem power manager;

FIG. 2 depicts a block diagram of an example embodiment of management subsystem functions selectively enabled and disabled to manage power consumption by the management subsystem;

FIG. 3 depicts a flow diagram of a process for managing power consumption by an information handling system management subsystem; and

FIG. 4 depicts power state transitions of one example of an information handling system management subsystem.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

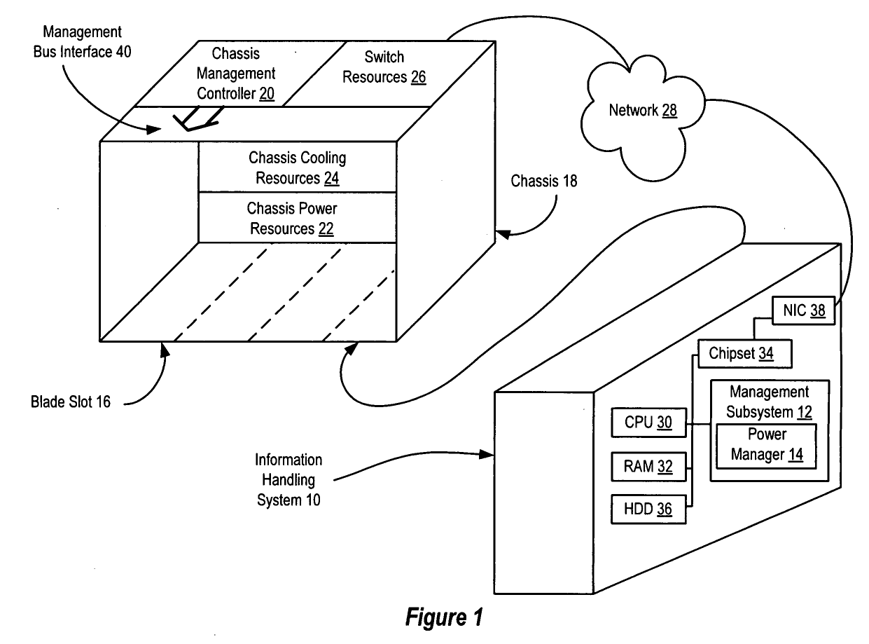

Referring now to FIG. 1, a block diagram depicts an information handling system 10 having a management subsystem 12 power manager 14. In the example embodiment depicted by FIG. 1, information handling system 10 is a blade sized to fit into a blade slot 16 of a chassis 18. Chassis 18 contains plural blade information handling systems 10 and manages operation of the systems with a chassis manager controller (CMC) 20. Chassis 18 includes infrastructure resources that are allocated by CMC 20 to the blade information handling systems, such as chassis power resources 22 that power the blades, chassis cooling resources 24 that cool the blades and switch resources 26 that support communication between the CMC 20, blade information handling systems 10 and a network 28, such as a local area network (LAN). Sharing of power, cooling and network resources between multiple information handling systems 10 reduces overall infrastructure costs. Although the example embodiment of FIG. 1 depicts a chassis 18 that supports multiple blade, alternative embodiments of management subsystem 12 power manager 14 may include individual information handling systems with dedicated power and cooling resources.

Information handling system 10 is built from a number of processing components that cooperate to process information, such as a CPU 30, RAM 32, a chipset 34, a hard disk drive 36, network interface cards (NIC) 38 and a management subsystem 12. In normal operations, CPU 30 processes information with instructions stored in RAM that were retrieved from permanent storage of hard disk drive 36 or from a network location through NIC 38. Chipset 34 coordinates operation of the processing components at a physical level with instructions stored in flash memory, such as a BIOS stored as firmware. Management subsystem 12 operates independently from the other processing components to manage operation of the system. For example, management subsystem 12 is a baseboard management controller (BMC) that interfaces with network 28 through a shared NIC or dedicated NIC to support remote power on and power off of information handling system 10. Management subsystem 12 also manages support infrastructure resources of information handling system 10. For example, management subsystem 12 monitors temperature sensors to maintain a proper operating temperature and coordinates power consumption with CMC 20 through a management bus interface 40, such as an 12C bus. Other functions supported by management subsystem 12 might include application of power to inventory devices, such as FRUs, SPDs, EDID, PCIe slots, auxiliary power and associated MUX devices; presentation of a control panel at a display; operation of BIOS ROM plus overwrite MUX devices; auxiliary cooling to cool the management subsystem when operating independent of the other processing components of information handling system 10; and management of internal persistent storage such as external optional SC cards and base flash memory.

Power manager 14 of management subsystem 12 manages power consumption by management subsystem 12 to help conserve power for better overall power consumption by information handling system 10. In one embodiment, power manager 14 places management subsystem 12 in a reduced power state when information handling system 10 is powered down. Upon a power up request for information handling system 10, power manager 14 recovers from its reduced power state, such as by performing a reboot, and then initiates power up of information handling system 10. During entry to the reduced power state of management subsystem 12, power manager 14 reboots or otherwise resets management subsystem 12 with a reduced power state flag set. Detection of the reduced power state flag during boot causes management subsystem to power down un-used devices and executes a tightly cached code having minimal memory accesses that detects wake events, such as a network packet with a specific wake command, a serial ring indicated or power button press. Thus, with power off the processing components of information handling system 10, management subsystem 12 enters a reduced power state in which it has substantially only the ability to recover to an operational state with substantially all other functions disabled, such as temperature sensing and cooling functions. Once a wake event is detected, management subsystem 12 recovers to an operational state from which it is capable of powering up information handling system 10 automatically or in response to a second wake event. In an alternative embodiment, a power manager 14 may be incorporated in CMC 20 so that CMC 20 enters a reduced power state if information handling systems 10 supported by chassis 18 are powered down. Management subsystem 20 can recover to a fully operational state by re-booting, by executing a recovery code or by other techniques.

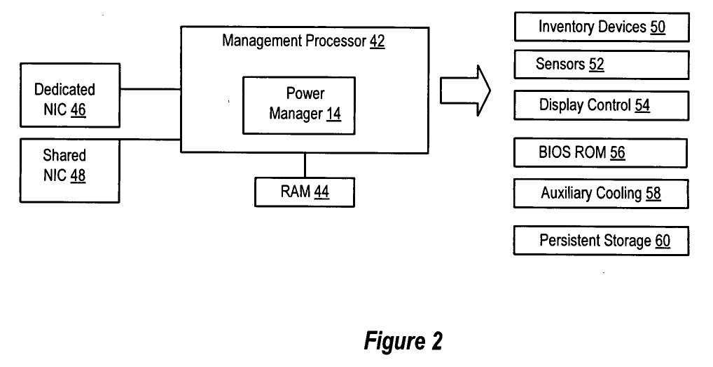

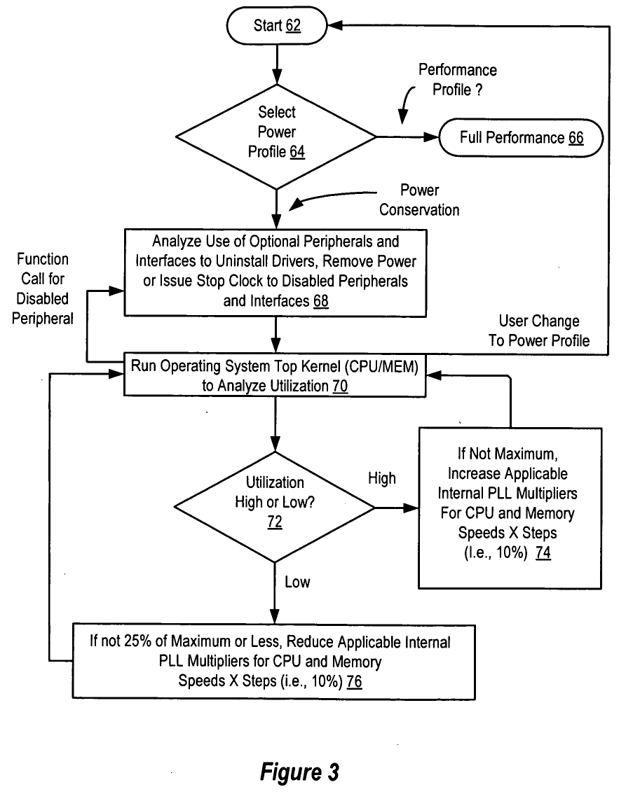

Referring now to FIG. 2, a block diagram depicts an example embodiment of management subsystem 12 functions selectively enabled and disabled to manage power consumption by management subsystem 12. Management subsystem 12 runs on a management processor 42 and associated RAM 44. Communication with a network is supported by a dedicated NIC 46 that serves only management subsystem 12 or a shared NIC 48 that also supports information handling system 10, such as a LAN on motherboard (LOM) NIC with wake-on-LAN (WOL) capability. Power manager is, for example, firmware code that runs on management processor 42. Power manager 42 commands entry of the reduced power state when the managed information handling system is powered down as set forth above, or enters reduced power states based on the utilization of management subsystem 12 as described below with respect to FIG. 3. In addition to a reduced power state having management subsystem 12 functionality disabled except for substantially only an ability to recover to a normal power state, power manager 14 selectively disables functions to obtain power savings, such as functions associated with inventory devices 50, sensors 52, control display 54, BIOS ROM 56, auxiliary cooling 58 and persistent storage 60. In addition, power manager 14 reduces power consumption by slowing the clock speed used by management processor 42 and RAM 44.

Referring now to FIG. 3, a flow diagram depicts a process for managing power consumption by an information handling system management subsystem. The process starts at step 62 with the management subsystem in an operational state. At step 64, an end user selects a power profile for operation of the management subsystem. If the end user selects a performance mode, the process continues to step 66 to end in a performance mode that does not enforce power savings with reduced power states. If at step 64 the user selects the use of one or more power saving techniques, the process continues to step 68 to enforce selected power savings techniques, such as by analyzing enablement of all optional peripheral, such as managed storage devices, and interfaces, such as a dedicated or shared NIC, and to uninstall drivers and issue a stop clock command for selectively disabled devices. As an example, with the managed information handling system in an operational mode, the power manager might shut down a dedicated NIC and maintain communication through a shared NIC or other management interface. The process continues to step 70 to run an operating system kernel, such as a LINUX top for process analysis and processor utilization. If a process requires a powered down device, the process returns to step 68 to restart the desired device. Once processor utilization is determined, the process continues to step 72 to determine if processor utilization is above or below a desired goal, such as within 20 percent of complete utilization for the current clock speed. If utilization is above a desired range, such as within 10 percent of complete utilization, the process continues to step 74 to increase clock speed unless the clock is already at maximum speed. For example, the internal phased loop lock (PLL) multiplier for the management processor and memory speeds is increased by 10 percent and the process returns to step 70. If at step 72 the processor utilization is low, the process continues to step 76 to reduce the clock speed so that utilization is increased. For example, the internal PLL multipliers for the management processor and memory speeds are reduced, such as by 10 percent, until a minimum value is reached, such as 25 percent of maximum. Once the management and processor clock speed are set, the process returns to step 70 to continue dynamic power management of the management subsystem.

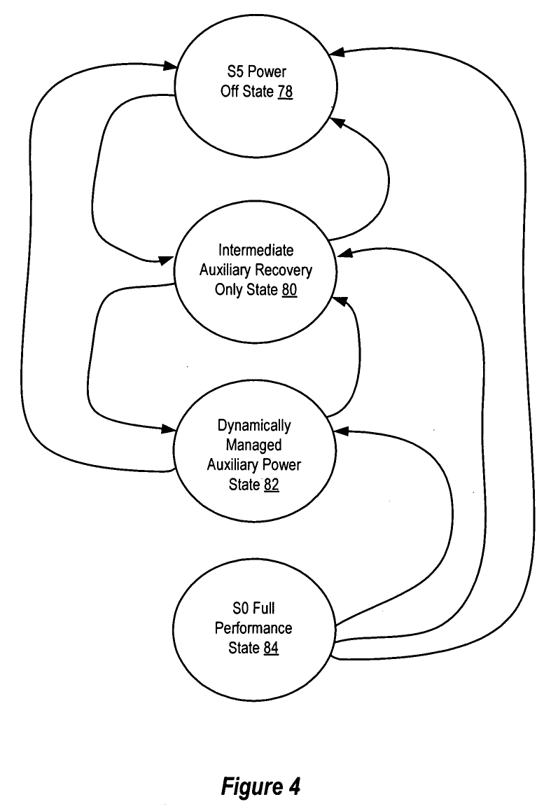

Referring now to FIG. 4, power state transitions of one example of an information handling system management subsystem are depicted. An S5AC power off state 78 is substantially an ACPI S5 state in which no power is applied to an information handling system. The information handling system transitions from state 78 to an intermediate state 80 in which the management subsystem has power to support substantially only functionality for bringing itself to an operational state. State 80 transitions to another intermediate state in which the management subsystem has power applied with dynamic management so that power consumption is limited to that needed to operate the system. For example, state 82 selectively adjusts the clock speed of the processor and memory running the management subsystem to maintain the processor in a desired range of utilization that reduces power consumption. State 82 transitions to a full performance state of substantially an SO ACPI state with the management subsystem and information handling system operating with full power available. Transitions between states 78, 80, 82, and 84 are supported by on user settings and system conditions.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
a network interface operable to support communication between the processing components and a network;
a management subsystem operable to manage the processing components and to communicate with the network through the network interface; and
a management subsystem power manager operable to selectively reduce power consumption of the management subsystem based on one or more predetermined conditions.

2. The information handling system of claim 1 wherein the management subsystem comprises a baseboard management controller.

3. The information handling system of claim 1 wherein the management subsystem comprises a chassis management controller.

4. The information handling system of claim 1 wherein the predetermined conditions comprise power down of the processing components.

5. The information handling system of claim 4 wherein the management subsystem power manager reduces power consumption by reducing management subsystem functions to substantially only an ability to recover to an operational state.

6. The information handling system of claim 5 wherein reducing management subsystem functions comprises disabling temperature sensor monitoring.

7. The information handling system of claim 5 wherein reducing management subsystem functions comprises disabling a cooling fan associated with cooling of the management subsystem.

8. The information handling system of claim 1 wherein predetermined conditions comprise predetermined utilization of a processor executing the management subsystem.

9. The information handling system of claim 8 wherein the management subsystem power manager reduces power consumption by reducing the clock speed of the processor to maintain utilization of the processor within a predetermined range.

10. The information handling system of claim 9 wherein the management subsystem power manager is further operable to increase the clock speed of the processor to maintain utilization of the processor within the predetermined range.

11. A method for managing power consumption or an information handling system, the method comprising:
controlling operations at the information handling system with a management subsystem;
detecting one or more predetermined conditions associated with the controlling; and
reducing power consumption of the management subsystem in response to the detecting.

12. The method of claim 11 wherein the management subsystem comprises a baseboard management controller.

13. The method of claim 11 wherein the predetermined conditions comprise a power down of the information handling system and reducing power consumption further comprises reducing management subsystem functions to substantially only an ability to recover to an operational state.

14. The method of claim 13 wherein reducing management subsystem functions comprises disabling temperature sensor monitoring.

15. The method of claim 11 wherein the predetermined condition comprises a predetermined utilization of a processor executing the management subsystem and reducing power consumption further comprises reducing a clock speed of the processor.

16. The method of claim 11 further comprising:
detecting a second predetermined condition; and
recovering a processor that executes the management subsystem in response to the second predetermined condition to bring the management subsystem to an operational state.

17. A system for managing power consumption of an information handling system, the system comprising:
a management processor;
memory interfaced with a management processor;
a management subsystem executing on the management processor and memory, the management subsystem operable to interface with a network, to accept remote commands through the network to power up and power down the information handling system, and to power up and power down the information handling system in response to the remote commands; and
a power manager running on the management processor, the power manager operable to detect one or more predetermined conditions and to adjust power consumption by the management subsystem in response to the one or more predetermined conditions.

18. The system of claim 17 wherein the predetermined condition comprises a remote power down of the information handling system and the power manager adjusts power consumption of the management subsystem in response to the remote power down command by reducing management subsystem functions to substantially only an ability to recover to an operational state.

19. The system of claim 17 wherein the predetermined condition comprises a predetermined utilization of the processor and adjusting power consumption comprises adjusting processor clock speed to maintain processor utilization within a predetermined range.

20. The system of claim 17 wherein the predetermined condition comprises a remote power up of the information handling system and the power manager adjusts power consumption of the management subsystem in response to the remote power up command by recovering the processor to bring the management subsystem to an operational state.
